(19) United States
(12) Patent Application Publication
(10) Pub. No.: US 2013/0258424 A1
(43) Pub. Date: Oct. 3, 2013

(54) POWER SUPPLY CONTROL DEVICE, IMAGE PROCESSING APPARATUS, AND NON-TRANSITORY COMPUTER READABLE MEDIUM STORING POWER SUPPLY CONTROL PROGRAM

(71) Applicants: Masafumi ONO, Kanagawa (JP); Kazuhiko NARUSHIMA, Kanagawa (JP); Motofumi BABA, Kanagawa (JP); Kenta OGATA, Kanagawa (JP); Kouichi AZUMA, Kanagawa (JP); Susumu YAMASHINA, Kanagawa (JP); Kenji KUROISHI, Kanagawa (JP); Keiko SHIRAISHI, Kanagawa (JP); Hidenori HORIE, Kanagawa (JP)

(72) Inventors: Masafumi ONO, Kanagawa (JP); Kazuhiko NARUSHIMA, Kanagawa (JP); Motofumi BABA, Kanagawa (JP); Kenta OGATA, Kanagawa (JP); Kouichi AZUMA, Kanagawa (JP); Susumu YAMASHINA, Kanagawa (JP); Kenji KUROISHI, Kanagawa (JP); Keiko SHIRAISHI, Kanagawa (JP); Hidenori HORIE, Kanagawa (JP)

(73) Assignee: FUJI XEROX CO., LTD., Tokyo (JP)

(21) Appl. No.: 13/596,772

(22) Filed: Aug. 28, 2012

(30) Foreign Application Priority Data
Mar. 27, 2012 (JP) 2012-071706

(51) Int. Cl. G06F 3/041; H04N 1/04

(52) U.S. Cl. 358/475; 345/173

(57) ABSTRACT

A power supply control device includes a user interface unit including a touch panel unit that has a display function and an input function and a backlight unit, a control unit that controls the process of a processing apparatus body, at least two types of moving body detecting units that are capable of detecting a moving body and have at least relatively short and long detectable distances, a stepwise power supply unit that supplies power to the control unit when one moving body detecting unit with a short detection distance starts detection at the time when the other movement detecting unit with a long detection distance detects the moving body and detects the moving body, and an adjustment unit that, when the one moving body detecting unit does not detect the moving body, first adjusts the brightness of the backlight unit to predetermined brightness less than normal brightness.

### CROSS-REFERENCE TO RELATED APPLICATIONS

This application is based on and claims priority under 35 USC 119 from Japanese Patent Application No 2012-071706 filed Mar. 27, 2012.

### BACKGROUND

(i) Technical Field

The present invention relates to a power supply control device, an image processing apparatus, and a non-transitory computer readable medium storing a power supply control program.

(ii) Related Art

A processing apparatus, for example, an image processing apparatus has a function of changing the operation mode to the power saving mode in which no power is supplied when the image processing apparatus is not used, in order to reduce power consumption.

### SUMMARY

According to an aspect of the invention, there is provided a power supply control device including: a user interface unit including a touch panel unit that has a display function of displaying indication information for indicating a process of a processing apparatus body and process information about the process of the processing apparatus body and an input function of enabling a user to touch a display region of the indication information to designate the indication information and a backlight unit that is turned on, on the rear side of the touch panel unit to clarify the display content; a control unit that controls the process of the processing apparatus body including the display function and the input function of the touch panel unit; at least two types of moving body detecting units that are capable of detecting a moving body which moves around the processing apparatus body and have at least relatively short and long detectable distances; a stepwise power supply unit that supplies power to the control unit when one of the moving body detecting units with a short detection distance starts detection at the time when the other movement detecting unit with a long detection distance detects the moving body and detects the moving body; and an adjustment unit that, when the one moving body detecting unit does not detect the moving body with power supplied to the control unit, first adjusts the brightness of the backlight unit to predetermined brightness less than normal brightness.

### BRIEF DESCRIPTION OF THE DRAWINGS

Exemplary embodiments of the present invention will be described in detail based on the following figures, wherein:

FIG. 1 is a communication network connection diagram including an image processing apparatus according to an exemplary embodiment;

FIG. 2 is a schematic diagram illustrating the image processing apparatus according to this exemplary embodiment;

FIG. 3 is a block diagram illustrating the structure of a control system of the image processing apparatus according to this exemplary embodiment;

FIG. 4 is a schematic diagram illustrating a main controller and a control system of the power supply device according to this exemplary embodiment for each function;

FIG. 5 is a timing chart illustrating each mode state and an event causing a change in the mode state in the image processing apparatus;

FIG. 6 is a plan view illustrating the image processing apparatus according to this exemplary embodiment and the periphery thereof;

FIG. 7 is a perspective view illustrating the image processing apparatus according to this exemplary embodiment and the periphery thereof;

FIG. 8 is a perspective view illustrating a cover member that is provided on the front surface of a pillar portion according to this exemplary embodiment;

FIG. 9 is a functional block diagram specialized for the adjustment of the brightness (luminance) of the backlight unit by the main controller;

FIGS. 10A and 10B are plan views illustrating the relative positional relationship between a moving body and the image processing apparatus (outside a region→into a region F);

FIGS. 11A and 11B are plan views illustrating the relative positional relationship between a moving body and the image processing apparatus (the region F→into a region N);

FIGS. 12A and 12B are plan views illustrating the relative positional relationship between a moving body and the image processing apparatus (the region N→away from the region F);

FIGS. 13A and 13B are plan views illustrating the relative positional relationship between a moving body and the image processing apparatus (the region F→away from the region);

FIG. 14 is a flowchart illustrating a power supply time monitoring control routine during power saving according to this exemplary embodiment which includes the adjustment of the brightness (luminance) of the backlight unit;

FIG. 15 is a characteristic diagram illustrating a stepwise reduction in the brightness (luminance) of the backlight unit; and

FIG. 16 is a route transition diagram illustrating the main relationship between the movement state and the power supply control state of a moving body (user) processed according to the flowchart shown in FIG. 14.

### DETAILED DESCRIPTION

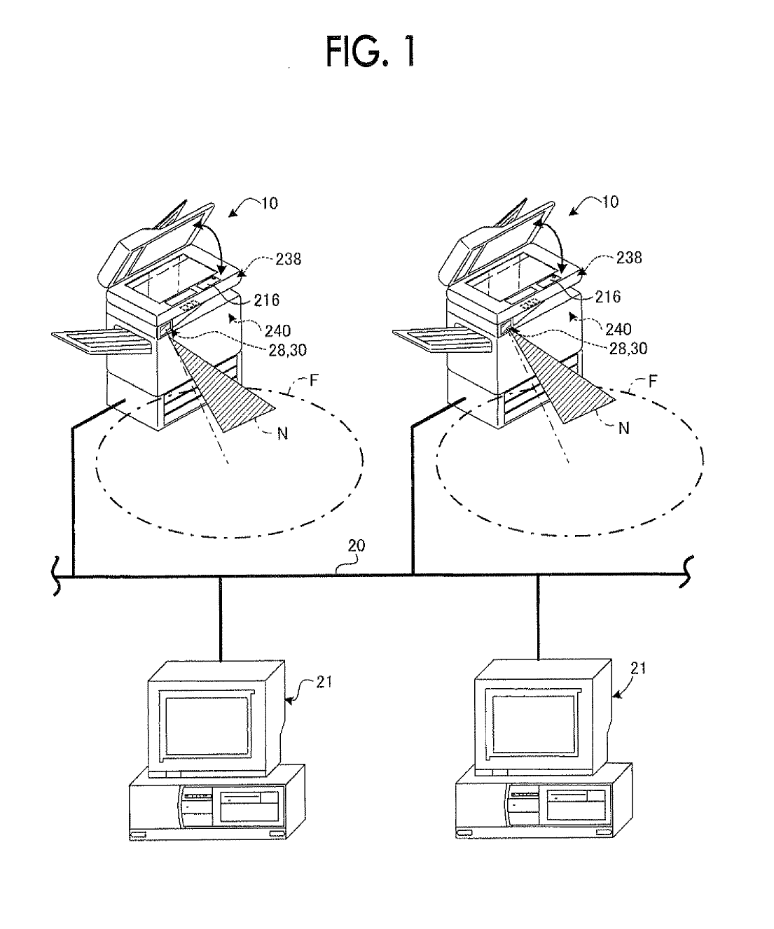

As shown in FIG. 1, an image processing apparatus 10 according to an exemplary embodiment is connected to a communication network 20, such as the Internet. In FIG. 1, two image processing apparatuses 10 are connected, but the number of image processing apparatuses 10 is not limited to two. For example, one or three or more image processing apparatuses 10 may be provided.

In addition, plural PCs (personal computers) 21 are connected as information terminal apparatuses to the communication network 20. In FIG. 1, two PCs 21 are connected, but the number of PCs 21 is not limited to two. For example, one PC 21 or three or more PCs 21 may be provided. The information terminal apparatus is not limited to the PC 21 and is not necessarily connected by wire. That is, a communication network that wirelessly transmits and receives information may be used.

As shown in FIG. 1, for example, the following operations are performed in the image processing apparatus 10: the PC 21 remotely transmits data to the image processing apparatus 10 and instructs the image processing apparatus 10 to form (print) an image; or the user stands in front of the image processing apparatus 10 and uses the image processing apparatus 10 to perform various operations, such as a copy, scanning (image reading), and the transmission and reception of a facsimile.

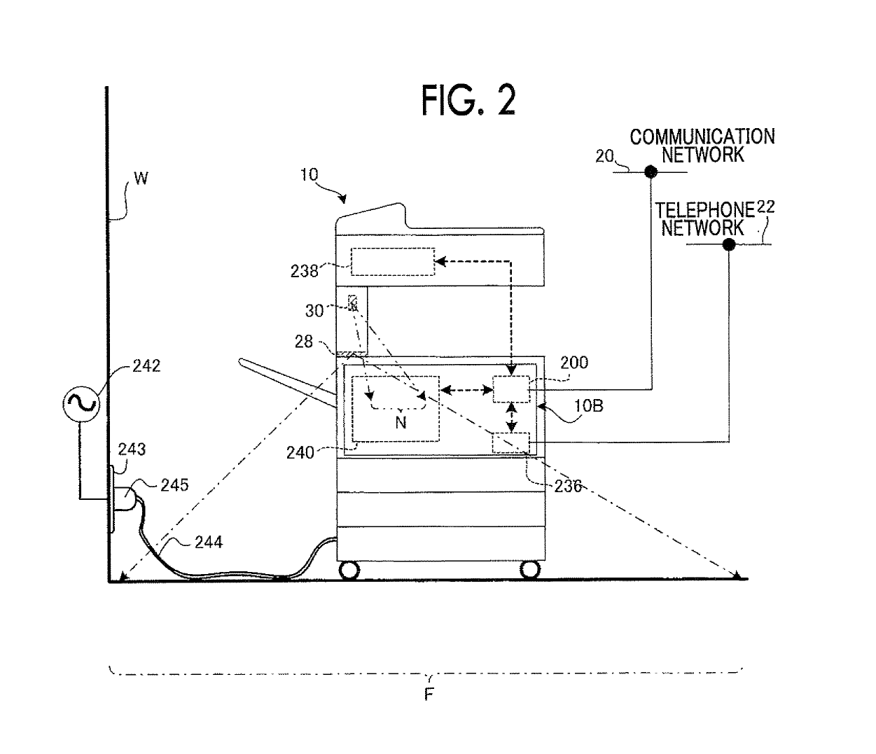

FIG. 2 shows the image processing apparatus 10 according to this exemplary embodiment.

The image processing apparatus 10 includes an image forming unit 240 that forms an image on a recording sheet, an image reading unit 238 that reads a document image, and a facsimile communication control circuit 236. The image processing apparatus 10 includes a main controller 200 and controls the image forming unit 240, the image reading unit 238, and the facsimile communication control circuit 236 such that data for the document image read by the image reading unit 238 is temporarily stored or the read image data is transmitted to the image forming unit 240 or the facsimile communication control circuit 236.

The communication network 20, such as the Internet, is connected to the main controller 200 and a telephone network 22 is connected to the facsimile communication control circuit 236. The main controller 200 is connected to a host computer through, for example, the communication network 20 and receives image data, or it transmits and receives a facsimile through the facsimile communication control circuit 236 using the telephone network 22.

The image reading unit 238 includes a document platen that positions a document, a scanning driving system that emits light to scan the image of the document on the document platen, and a photoelectric conversion element, such as a CCD that receives light reflected from or passing through the document during the scanning of the scanning driving system and converts the received light into an electric signal.

The image forming unit 240 includes a photoconductor, and a charging device that uniformly charges the photoconductor, a scanning exposure unit that scans light beams on the basis of image data, an image developing unit that develops an electrostatic latent image formed by the scanning exposure of the scanning exposure unit, a transfer unit that transfers the developed image on the photoconductor onto a recording sheet, and a cleaning unit that cleans the surface of the photoconductor after the transfer operation are provided around the photoconductor. In addition, a fixing unit that fixes the transferred image on the recording sheet is provided on the transport path of the recording sheet.

In the image processing apparatus 10, a plug 245 is attached to the leading end of an input power line 244 and is inserted into a wiring plate 243 of a commercial power supply 242 which is wired to a wall surface W such that the image processing apparatus 10 is supplied with power from the commercial power supply 242.

Hardware Structure of Control System of Image Processing Apparatus

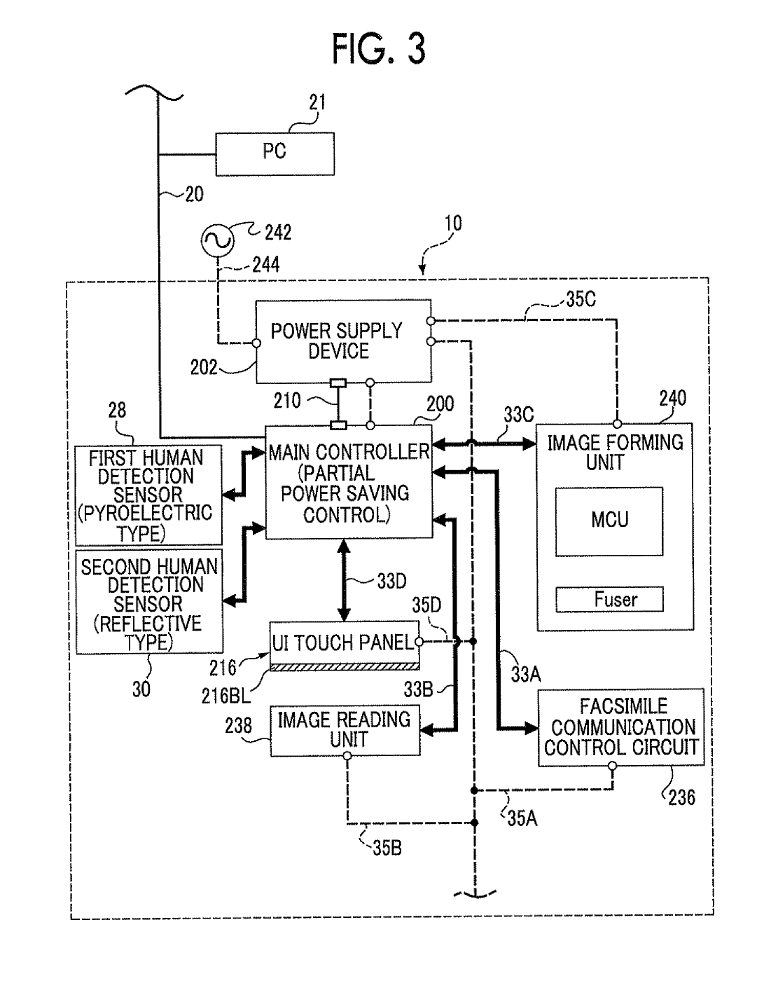

FIG. 3 is a schematic diagram illustrating the hardware structure of the control system of the image processing apparatus 10.

The communication network 20 is connected to the main controller 200. The facsimile communication control circuit 236, the image reading unit 238, the image forming unit 240, and a UI touch panel 216 are connected to the main controller 200 through buses 33A to 33D, such as data buses or control buses, respectively. That is, the main controller 200 mainly controls each processing unit of the image processing apparatus 10. A UI touch panel backlight unit 216BL is attached to the UI touch panel 216.

In addition, the image processing apparatus 10 includes a power supply device 202 which is connected to the main controller 200 by a signal harness 201.

The power supply device 202 is supplied with power from the commercial power supply 242 through the input power line 244.

The power supply device 202 includes power supply lines 35A to 35D through which power is independently supplied to the main controller 200, the facsimile communication control circuit 236, the image reading unit 238, the image forming unit 240, and the UT touch panel 216. Therefore, the main controller 200 may perform so-called partial power saving control in which power is supplied to each processing unit (device) (power supply mode) or the supply of power to each processing unit is cut (sleep mode).

Two human detection sensors, that is, a first human detection sensors 28 and a second human detection sensor 30 are connected to the main controller 200 and monitor the presence or absence of a person around the image processing apparatus 10. The first human detection sensor 28 and the second human detection sensor 30 will be described below.

Functional Block Diagram of Partial Power Saving Structure as Main Structure

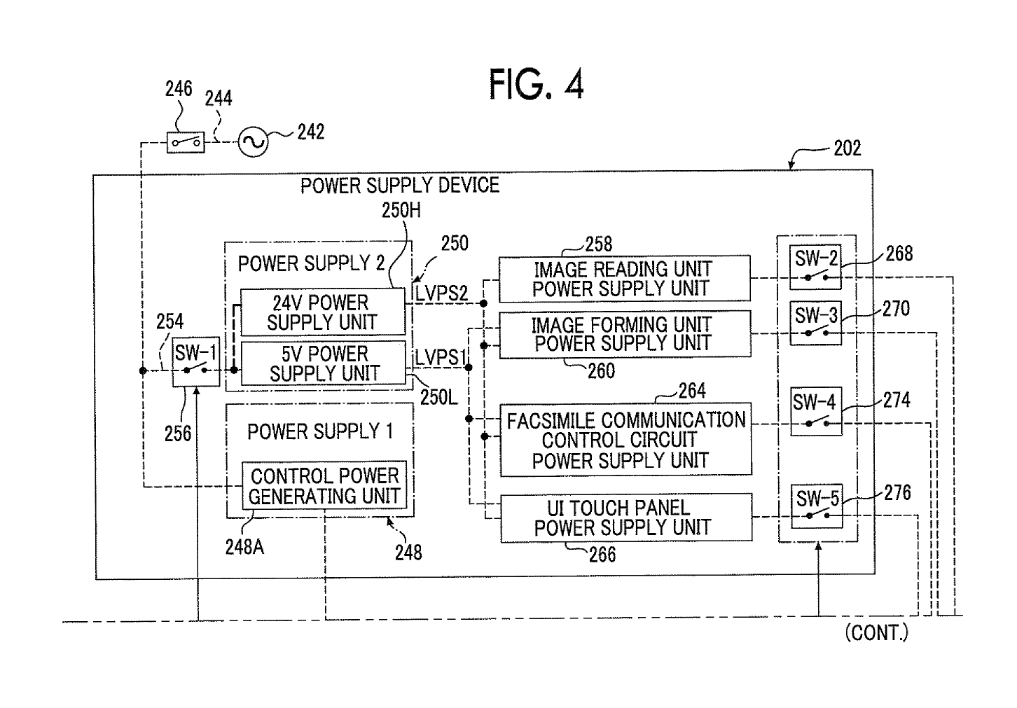

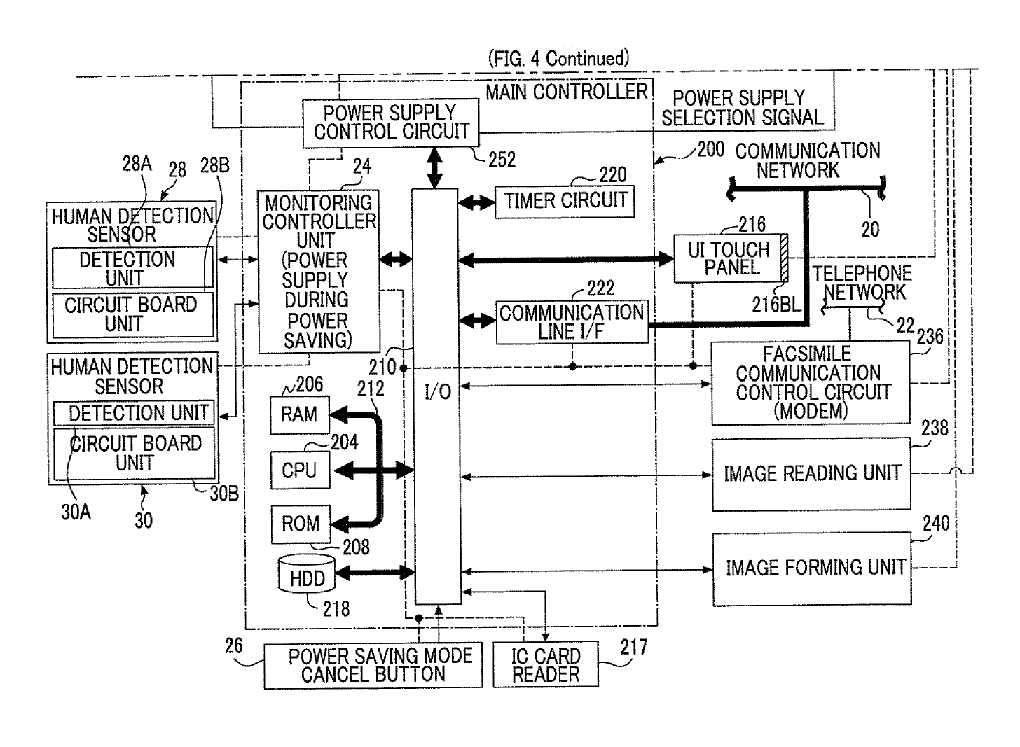

FIG. 4 is a schematic diagram illustrating operation units (for example, in some cases, referred to as “processing units”, “devices”, and “modules”) controlled by the main controller 200, the main controller 200, and the power line of the power supply device 202 for supplying power to each device as main components. In this exemplary embodiment, the image processing apparatus 10 may supply power or cut the supply of power to each processing unit (partial power saving control). The partial power saving control for each processing unit is an illustrative example. The power saving control may be performed for each group of the processing units.

The partial power saving control may be performed for the main controller 200. When the power saving control is performed for all of the processing units, a power saving monitoring control unit 24 (which will be described below) receives minimum necessary power and cuts the supply of power to other control devices (in some cases, referred to as the “power saving mode” or the “sleep mode”).

Main Controller 200

As shown in FIG. 4, the main controller 200 includes a CPU 204, a RAM 206, a ROM 208, an I/O (input/output unit) 210, and a bus 212, such as a data bus or a control bus that connects the components. The UI touch panel 216 (including the backlight unit 216BL) is connected to the I/O 210. In addition, a hard disk (HDD) 218 is connected to the I/O 210. The CPU 204 operates on the basis of a program stored in, for example, the ROM 208 or the hard disk 218 to implement the functions of the main controller 200. The program may be installed from a recording medium (for example, a CD, a DVD, a BD (Blu-ray Disc), a USB memory, and a SD memory) storing the program and the CPU 204 may operate on the basis of the program to implement an image processing function.

A timer circuit 220 and a communication line I/F 222 are connected to the I/O 210. In addition, each device of the facsimile communication control circuit (MODEM) 236, the image reading unit 238, and the image forming unit 240 is connected to the I/O 210.

The timer circuit 220 measures time in order to change the facsimile communication control circuit 236, the image reading unit 238, and the image forming unit 240 to a power saving state (power supply cut state) (hereinafter, referred to as a “system timer” in some cases).

The main controller 200 and each device (the facsimile communication control circuit 236, the image reading unit 238, and the image forming unit 240) are supplied with power from the power supply device 202 (see a dotted line in FIG. 4). In FIG. 4, the power line is shown as one line (dotted line), but is actually two or three lines.

Power Supply Device 202

As shown in FIG. 4, the input power line 244 drawn from the commercial power supply 242 is connected to a main switch 246. When the main switch 246 is turned on, power may be supplied to the second power supply unit 250 through a first power supply unit 248 and a first sub-power switch 256.

The first power supply unit 248 includes a control power generating unit 248A and is connected to a power supply control circuit 252 of the main controller 200. The power supply control circuit 252 supplies power to the main controller 200, is connected to the I/O 210, and performs switching control for turning on and off the connection of the power line to each device (the facsimile communication control circuit 236, the image reading unit 238, and the image forming unit 240) according to a control program of the main controller 200.

A first sub-power switch 256 (hereinafter, referred to as an “SW-1” in some cases) is interposed between a power line 254 (ground side) and a second power supply unit 250. The power supply control circuit 252 controls the on and off states of the SW-1. That is, when the SW-1 is turned off, the second power supply unit 250 does not operate (components after the “SW-1” consume no power).

The second power supply unit 250 includes a 24 V power supply unit 250H (LVPS2) and a 5 V power supply unit 250L (LVPS1) The 24 V power supply unit 250H (LVPS2) is mainly used in, for example, a motor.

The 24 V power supply unit 250H (LVPS2) and the 5 V power supply unit 250L (LVPS1) of the second power supply unit 250 are selectively connected to an image reading unit power supply unit 258, an image forming unit power supply unit 260, a facsimile communication control circuit power supply unit 264, and a UI touch panel power supply unit 266.

The image reading unit power supply unit 258 is supplied with power from the 24 V power supply unit 2505 (LVPS2) and is connected to the image reading unit 238 through a second sub-power switch 268 (hereinafter, referred to as an “SW-2” in some cases).

The image forming unit power supply unit 260 is supplied with power from the 24 V power supply unit 250H (LVPS2) and the 5 V power supply unit 250L (LVPS1) and is connected to the image forming unit 240 through a third sub-power switch 270 (hereinafter, referred to as an “SW-2” in some cases).

The facsimile communication control circuit power supply unit 264 is supplied with power from the 24 V power supply unit 250H (LVPS2) and the 5 V power supply unit 250L (LVPS1) and is connected to the facsimile communication control circuit 236 and the image forming unit 240 through a fourth sub-power switch 274 (hereinafter, referred to as an “SW-4” in some cases).

The UI touch panel power supply unit 266 is supplied with power from the 5 V power supply unit 250L (LVPS1) and the 24 V power supply unit 250H (LVPS2) and is connected to the UI touch panel 216 (including the backlight unit 216BL) through a fifth sub-power switch 276 (hereinafter, referred to as an “SW-5” in some cases).

The turning on and off of each of the second sub-power switch 268, the third sub-power switch 270, the fourth sub-power switch 274, and the fifth sub-power switch 276 is controlled on the basis of a power supply selection signal from the power supply control circuit 252 of the main controller 200, similarly to the first sub-power switch 256. Although not shown in the drawings, power is supplied from the 24V power supply unit 250H and the 5V power supply unit 250L through two systems of switches and lines. In addition, the power supply switches 268 to 276 may be provided in each device, which a power supply destination, not in the power supply device 202. The fixing unit (corresponding to a “Fuser” shown in FIG. 3) of the image forming unit (not shown) is supplied with power from the commercial power supply 242 through the first sub-power switch 256 (“SW-1”) and is turned on in the image forming unit 240 only if necessary.

In the above-mentioned structure, power is supplied to the devices (the facsimile communication control circuit 236, the image reading unit 238, and the image forming unit 240) which are selected so as to be suitable for each function and power is not supplied to the device which is not necessary for the instructed function. Therefore, it is possible to supply minimum necessary power.

Monitoring Control for Changing State of Image Processing Apparatus

In this exemplary embodiment, in some cases, the main controller 200 partially stops its functions such that minimum necessary power is consumed (partial power saving). Alternatively, in some cases, the main controller 200 stops the supply of power to most of the units (“sleep mode” (power saving mode)).

For example, the system timer starts at the time when image processing ends, thereby changing the operation mode to the sleep mode. That is, power supply is stopped when a predetermined time has elapsed from the start of the system timer. When any operation (for example, a hardware key operation) is performed until a predetermined time elapses, the timer count for changing to the sleep mode is stopped and the system timer starts after the next image processing ends.

In the sleep mode, the power saving monitoring control unit 24 (see FIG. 4), which is an element that is constantly supplied with power, is connected to the I/O 210. The power saving monitoring control unit 24 may include, for example, an IC chip which is referred to as an ASIC, stores an operation program therein, and includes a CPU, a RAM, and a. ROM processed by the operation program.

However, during monitoring in the power saving mode, it is assumed that, for example, when a print request is received from a communication line detecting unit and a FAX reception request is received from a FAX line detecting unit, the power saving monitoring control unit 24 controls the first sub-power switch 256, the second sub-power switch 268, the third sub-power switch 270, the fourth sub-power switch 274, and the fifth sub-power switch 276 through the power supply control circuit 252, thereby supplying power to the devices in the power saving mode.

Power Supply/Power Supply Cutting Control of Main Controller

As shown in FIG. 4, a power saving control button 26 (in some cases, simply referred to as a “power saving button 26”) is connected to the I/O 210 of the main controller 200. The user presses the power saving control button 26 in the power saving mode to cancel the power saving mode. The power saving control button 26 is operated when power is supplied to the processing unit and has a function of forcibly cutting the supply of power to the processing unit to change the operation mode to the power saving state. In addition, an IC card reader 217 is connected to the I/O 210 of the main controller 200.

In order to perform monitoring in the sleep mode, it is preferable that minimum necessary power be supplied to the power saving control button 26 or each detecting unit in the power saving mode, in addition to the power saving monitoring control unit 24. That is, even in the sleep mode in which no power is supplied, in some cases, power required to determine whether to supply power equal to or less than a predetermined power (for example, 0.5 W or less) is supplied.

As a specific period in the sleep mode, a period for which minimum necessary power is mainly supplied to an input system, such as the main controller 200, the UI touch panel 216, or the IC card reader 217 may be provided. The period is provided considering user convenience. It is not particularly important to define the specific period in the sleep mode as the sleep mode or another mode. For example, when the sleep mode is defined as a mode in which “power consumption is equal to or less than a predetermined power saving level”, the mode of the specific period may be determined on the basis of whether power consumption for the specific period in the sleep mode is maintained at the predetermined power saving level or less.

For example, in the sleep mode, when the user operates the power saving control button 26 to select a copy function as the processing function, first, the main controller 200 starts to enable the user to operate the UI touch panel 216 or perform card authentication using the IC card reader 217, selects the device according to the operation situation of the user, and supplies power to the device, for the specific period. In this case, it is possible to improve convenience and reduce energy consumption. In addition, for the specific period, the human detection sensor may be used to detect a person.

Functions of Human Detection Sensor

However, when the user stands in front of the image processing apparatus 10 and operates the power saving control button 26 to resume power supply in the sleep mode, it take a time to start the image processing apparatus 10 in some cases.

Therefore, the first human detection sensor 28 and the second human detection sensor 30 are provided in the power saving monitoring control unit 24, the human detection sensor is used to detect the user before the user presses the power saving mode cancel button, and power supply is resumed in the sleep mode such that the user rapidly uses the image processing apparatus 10. In addition, the power saving control button 26, the first human detection sensor 28, and the second human detection sensor 30 are used jointly. However, only the first human detection sensor 28 and the second human detection sensor 30 may be used to monitor all situations.

As shown in FIG. 4, the first human detection sensor 28 and the second human detection sensor 30 include detecting units 28A and 30A and circuit board units 288 and 30B, respectively. The circuit board units 28B and 308 adjust the sensitivity of the signals detected by the detecting units 28A and 30A or generate output signals.

The first human detection sensor 28 and the second human detection sensor 30 detect a “person”. The term “human detection” is a proper noun defined in this exemplary embodiment. The first human detection sensor 28 and the second human detection sensor 30 may sense (detect) at least a person. In other words, the term “human detection” includes the sensing (detection) of moving bodies in addition to persons. Therefore, in the following description, in some cases, the detection target of the human detection sensor is a “person”, but may in the future include, for example, robots that perform operations instead of persons. Conversely, when there is a special sensor capable of detecting only persons, the specific sensor may be applied. In the following description, moving bodies, persons, and users are treated as the detection targets of the first human detection sensor 28 and the second human detection sensor 30, and they are distinguished from each other, if necessary.

First Human Detection Sensor 28

According to the specifications of the first human detection sensor 28 according to this exemplary embodiment, the first human detection sensor 28 detects the movement of a moving body around the image processing apparatus 10 (for example, in a range of 1 m to 5 m). In this case, a representative example of the first human detection sensor 28 is an infrared sensor using the pyroelectric effect of a pyroelectric element (pyroelectric sensor). In this exemplary embodiment, a pyroelectric sensor is applied as the first human detection sensor 28.

The most distinctive feature of the sensor which uses the pyroelectric effect of the pyroelectric element and is applied to the first human detection sensor 28 is a wide detection range. In addition, the sensor does not detect the presence of a person when the person stands still in the detection region since it detects the movement of a moving body. For example, in a case in which a high-level signal is output during the movement of a person, when the person stands still within the detection range, the signal changes to a low-level signal.

In this exemplary embodiment, the term “standstill” includes a complete standstill like a still image captured by, for example, a still camera and a state in which a person stands in front of the image processing apparatus 10 in order to perform an operation. Therefore, the standstill includes a micromotion in a predetermined range (for example, a motion including breath) and the movement of limbs and the head.

However, when a person stretches in front of the image processing apparatus 10 while waiting for, for example, an image forming process or an image reading process, the human detection sensor 28 detects the presence of the person in some cases.

Therefore, a threshold value used by the first human detection sensor 28 to detect a motion may be roughly and normally set and the detection state of the first human detection sensor 28 may depend on an environment (for example, temperature and humidity), without defining the term “standstill” and setting the threshold value. That is, the threshold value may be set experimentally or statistically in the place where the apparatus is installed as follows: when the first human detection sensor 28 outputs one (for example, a high-level signal) of binary signals, the threshold indicates that a person moves; and when there is a person in the detection region of the first human detection sensor 28 and one (for example, a low-level signal) of the binary signals is output, the threshold value indicates that the person stands still.

According to the specifications of the first human detection sensor 28 according to this exemplary embodiment, the first human detection sensor 28 detects the movement of a moving body around the image processing apparatus 10 (for example, in a range of 0 m to 5 m).

Second Human Detection Sensor 30

According to the specifications of the second human detection sensor 30 according to this exemplary embodiment, the second human detection sensor 30 detects whether there is a moving body (presence or absence of a moving body). A representative example of the sensor applied to the second human detection sensor 30 is a reflective sensor including a light emitting unit and a light receiving unit (reflective sensor). The light emitting unit may be separated from the light receiving unit.

The most distinctive feature of the reflective sensor applied to the second human detection sensor 30 is to reliably detect the presence or absence of a moving body on the basis of whether light incident on the light receiving unit is shielded or not. In addition, since the amount of light incident on the receiving unit is limited by the amount of light emitted from the light emitting unit, the detection region of the sensor is relatively narrow.

The first human detection sensor 28 is not limited to the pyroelectric sensor and the second human detection sensor 30 is not limited to the reflective sensor as long as the first human detection sensor 28 and the second human detection sensor 30 may have the following functions.

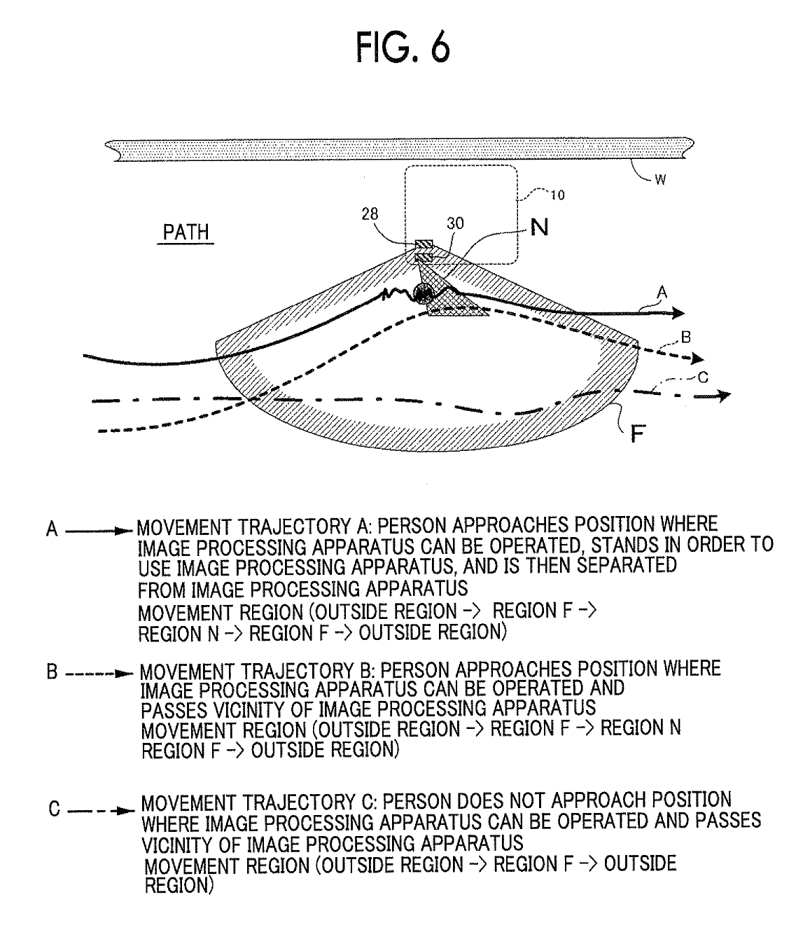

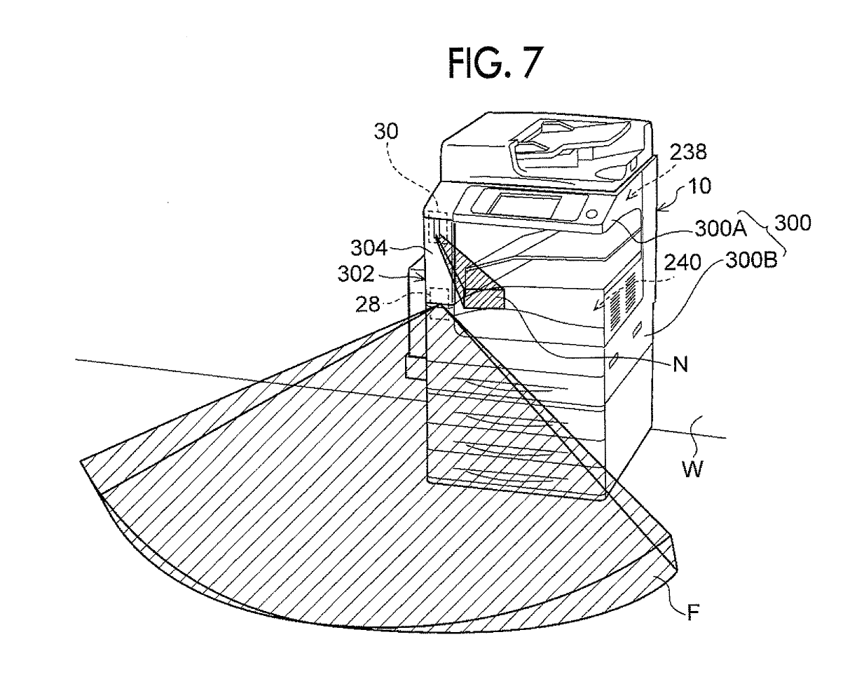

In this exemplary embodiment, a maximum detection range (for example, a first region F and a second region N in FIGS. 6 and 7) is set by the first human detection sensor 28 and the second human detection sensor 30.

The first region F (in some cases, simply referred to as a “region F”) in FIG. 6, which is a relatively distant detection region, is the detection region of the first human detection sensor 28 and functions as a relatively distant moving body detecting unit. The second region N (in some cases, simply referred to as a “region N”) in FIG. 6, which is a relatively near detection region, is the detection region of the second human detection sensor 30 and functions as a relatively near moving body detecting unit.

The detection region (see the first region F in FIG. 6) of the first human detection sensor 28 depends on the environment of the place where the image processing apparatus 10 is installed and it is preferable that a critical point (farthest position) be in the range of about 0.8 m to 3 m only as a guide. In the detection region (see the second region N in FIG. 6) of the second human detection sensor 30, the UI touch panel 216 or the hardware key of the image processing apparatus 10 may be operated and it is preferable that a critical point (farthest position) be in the range of about 0.2 m to 1.0 m only as a guide. Of course, after both the detection ranges are set, the critical point of the first human detection sensor 28 is more distant than that of the second human detection sensor 30.

First Human Detection Sensor 28, Second Human Detection Sensor 30, and Other Peripheral Structures

As shown in FIG. 7, in the image processing apparatus 10, for example, the image reading device 238 and the image forming device 240 are covered with a housing 300 and the first human detection sensor 28 (including the second human detection sensor 30) is attached to a pillar portion 302 with a vertically elongated rectangular shape in the housing 300. The pillar portion 302 connects an upper housing 300A that covers the image reading device 238 and a lower housing 300B that covers the image forming device 240 and has a recording sheet transport system provided therein.

A cover member 304 with a vertically elongated rectangular shape that covers the pillar portion 302 with a design element is attached the front surface of the pillar portion 302.

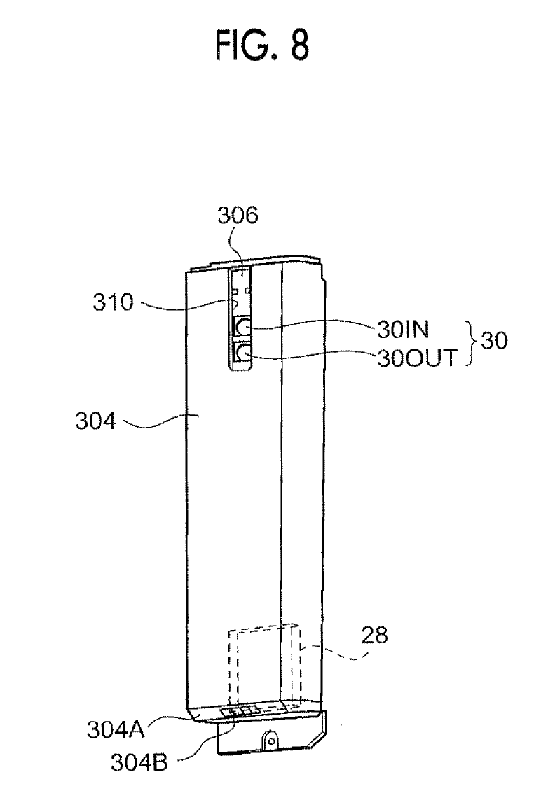

A gap is provided between the lower surface of the cover member 304 and the upper surface of the lower housing 300B. As shown in FIG. 8, so-called chamfering (chamfered portion 304A) is performed on the lower end of the cover member 304 and the opening area of the gap 312 is greater than the dimensions of a gap on the rear side.

A rectangular through hole 304B is provided in the chamfered portion 304A and the first human detection sensor 28 is attached thereto. Therefore, the through hole 304B functions as a monitoring window for detecting a moving body using the first human detection sensor 28. Hereinafter, in some cases, the through hole 304B is referred to as a monitoring window 304B.

Since the monitoring window 304B is provided in the chamfered portion 304A, it is less likely to be viewed from the front side of the apparatus, as compared to a structure in which it is provided in the front surface, and the design element of the cover member 304 is not damaged.

As shown in FIG. 8, a vertically long slit 310 is provided at the upper end of the cover member 304 in FIG. 8, and the second human detection sensor 30 is provided on the rear surface of the slit 310. The second human detection sensor 30 includes a light receiving unit 301N and a light emitting unit 30017 as the detecting unit 30A. The detecting unit 30A is attached to the circuit board unit 30B. The circuit board unit 30B is attached to a base member 306.

Sensor Power Supply Control

In this exemplary embodiment, the second human detection sensor 30 is not constantly supplied with power. The second human detection sensor 30 is supplied with power and operates at the time when a moving body (user) enters the first region F in FIG. 6 which is under the control of the first human detection sensor 28. Then, a change in the operation mode from the sleep mode to the standby mode is instructed at the time when the moving body (user) enters the second region N in FIG. 6 which is under the control of the second human detection sensor 30.

That is, two human detection sensors (the first human detection sensor 28 and the second human detection sensor 30) with different detection regions cooperate with each other such that minimum necessary power is supplied.

The supply of power to the second human detection sensor 30 is cut by both the detection situation of the moving body by the first human detection sensor 28 and the timer function of the power saving monitoring control unit 24. In some cases, the timer function is referred to as a “sensor timer” in order to distinguish it from the above-mentioned system timer.

The sensor timer is one of the functions of the power saving monitoring control unit 24. That is, of course, the control system includes an operation clock. The control system may generate the timer from the clock signal or it may generate a counter program that counts the time for each process at a predetermined time interval.

As shown in FIG. 6, the relationships between the moving body (user) and the image processing apparatus 10 are mainly classified into three aspects. In the first aspect, a person approaches the position where the image processing apparatus 10 may be operated in order to use the image processing apparatus 10 (see movement represented by an arrow A in FIG. 6 (pattern A)). In the second aspect, a person approaches the position where the image processing apparatus may be operated, without intending to use the image processing apparatus (see movement represented by an arrow B in FIG. 6 (pattern B)). In the third aspect, a person does not reach the position where the image processing apparatus may be operated, but is at a distance where the aspect is likely to be changed to the first aspect or the second aspect (see movement represented by an arrow C in FIG. 6 (pattern C)).

In this exemplary embodiment, the time when power is supplied to the second human detection sensor 30 and the time when the supply of power to the second human detection sensor 30 which are suitable for the movement (moving aspect of the person based on patterns A to C shown in FIG. 6) are controlled on the basis of information detected by the first human detection sensor 28, and information detected by the first human detection sensor 28 and information about the time measurement of the sensor timer.

However, when the power supply system is different in the approaching state and the separated state of the moving body (user), for example, when the person approaches in order to use the image processing apparatus 10, the time when power is supplied to the image processing apparatus 10 is not clear in some cases. In this case, an indicator (for example, an LED) that reacts to the approach of a moving body and is turned on may be provided in the pillar portion 304 (see FIG. 7) attached the first human detection sensor 28 or the second human detection sensor 30, and may be turned on and off to notify that it has reacted to the approach or separation of the person.

However, in many cases, the user who is intending to use the image processing apparatus 10 mainly looks at the UI touch panel unit 216. Therefore, it is difficult for the user to look at the on and off states of the indicator provided in the pillar portion 304 and check a power supply state (transition state).

In this exemplary embodiment, the on and off states of the backlight unit 216BL of the UI touch panel unit 216 are controlled in cooperation with the detection of the moving body (user) by the first human detection sensor 28 and the second human detection sensor 30.

In this exemplary embodiment, light amount control is applied to control the on and off states of the backlight unit 216BL. The light amount control is performed during the specific period in the sleep mode.

The specific period in the sleep mode means a period for which the second human detection sensor 30 detects a person and the main controller 200 starts to enable the operation of the UI touch panel 216 in the sleep mode.

In this case, the luminance (brightness) of the backlight unit 216BL for illuminating the screen of the UI touch panel 216 may be adjusted in plural stages (hereinafter, referred to as “luminance adjustment” or “brightness adjustment” in some cases) and the brightness is controlled in cooperation with the approach and separation of a person.

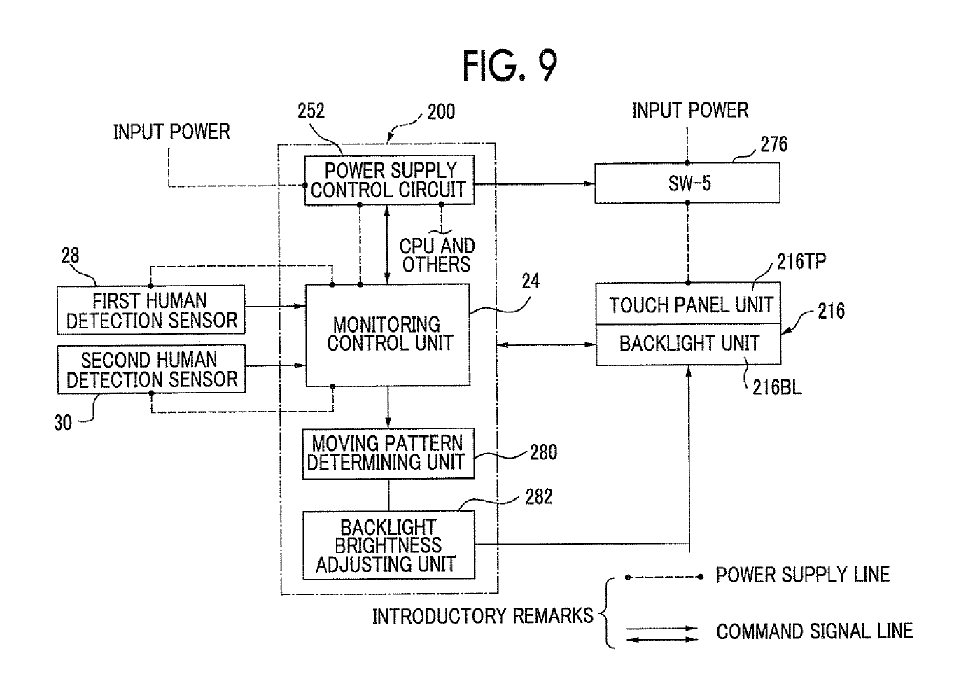

FIG. 9 is a functional block diagram illustrating the luminance adjustment of the backlight unit 216BL by the main controller 200. The functional block diagram does not limit the hardware structure of the main controller 200.

The monitoring control unit 24 is supplied with power from the power supply control circuit 252 even in the sleep mode. In addition, the monitoring control unit 24 constantly supplies power to the first human detection sensor 28. The monitoring control unit 24 supplies power to the second human detection sensor 30 at the time when the first human detection sensor 28 detects a moving body.

The power supply control circuit 252 is a portion of the main controller 200 and supplies power to another component, such as the CPU 204, when user detection information is input from the second human detection sensor 30 through the monitoring control unit 24 (the main controller 200 starts).

The UI touch panel 216 includes a touch panel unit 216TP and a backlight unit 216BL. When the SW-5276 is turned on by the control of the power supply control circuit 252, the UI touch panel 216 is supplied with power. In this exemplary embodiment, power is supplied to the UI touch panel 216 in synchronization with the start of the main controller 200.

As shown in FIG. 9, the monitoring control unit 24 of the main controller 200 is connected to the moving pattern determining unit 280. Information based on the detection of the moving body by the first human detection sensor 28 and the second human detection sensor 30 which are connected to the monitoring control unit 24 is input to the moving pattern determining unit 280.

The moving pattern determining unit 280 determines the patterns in which three kinds of positions are moved with respect to each other, on the basis of the information based on the detection of the moving body (in the region F and the region N shown in FIG. 6, three kinds of positions, that is, a position outside the regions F and N, a position which is in the region F and is outside the region N, and a position in the region N).

The moving pattern determining unit 280 is connected to a backlight brightness adjusting unit 282. The backlight brightness adjusting unit 282 receives moving pattern information from the moving pattern determining unit 280 and adjusts the brightness of the backlight unit 216BL to be less than normal brightness.

Power supply including the adjustment of the brightness of the backlight unit 216BL in the sleep mode is mainly classified into four steps.

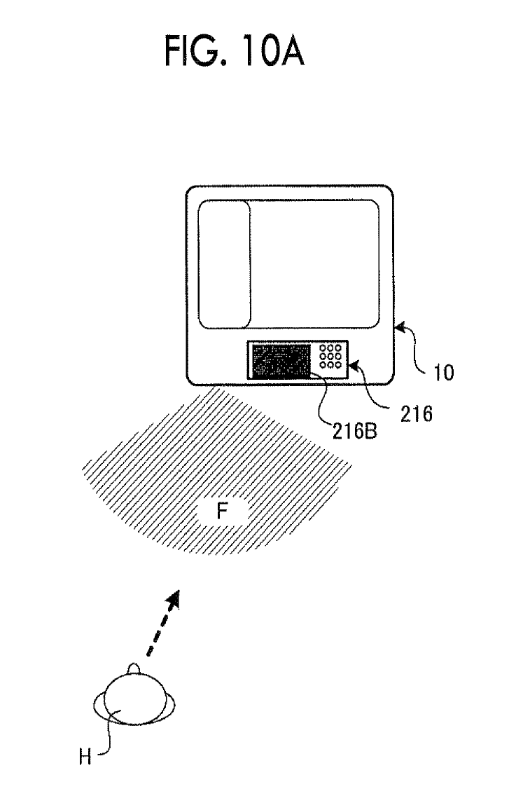

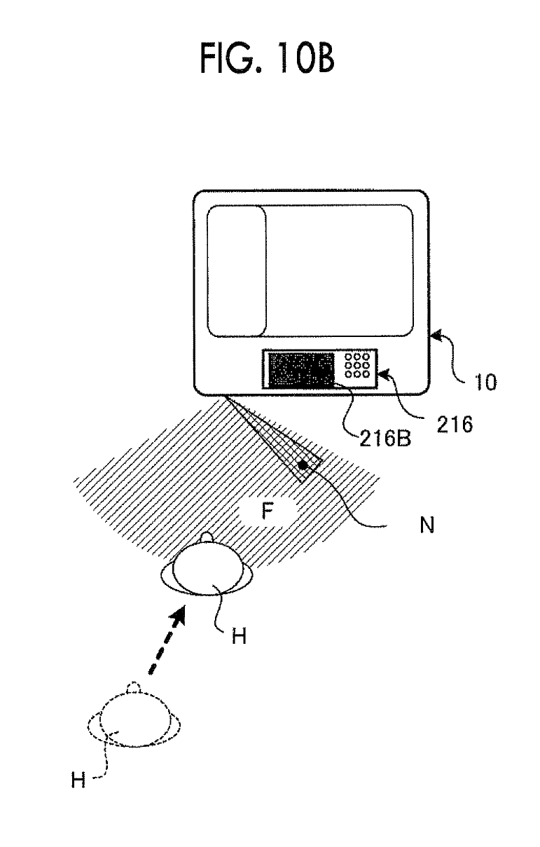

(Step 1) When the first human detection sensor 28 detects a moving body, power is supplied to the second human detection sensor 30 (see FIGS. 10A and 10B).

That is, as shown in FIG. 10A, when a moving body (which is represented by letter H in FIGS. 10A and 10B) is outside the region F of the first human detection sensor 28, no power is supplied to the second human detection sensor 30. In this state, as shown in FIG. 10B, when the moving body enters the region F of the first human detection sensor 28, power is supplied to the second human detection sensor 30 and the detection region of the second human detection sensor 30 is generated.

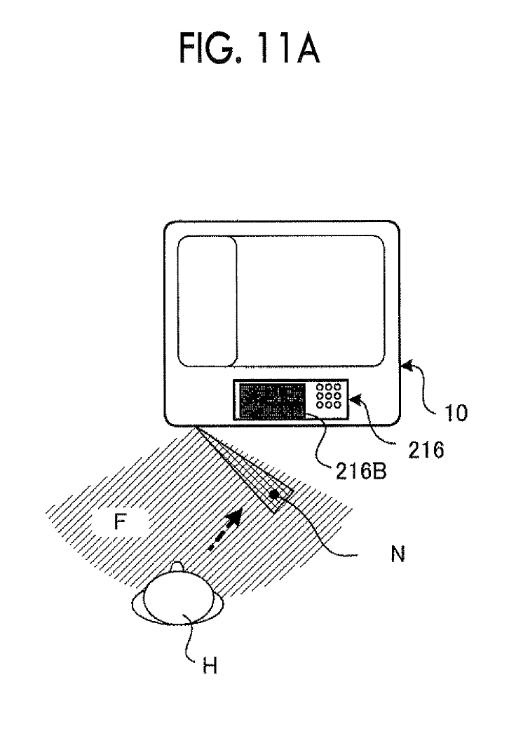

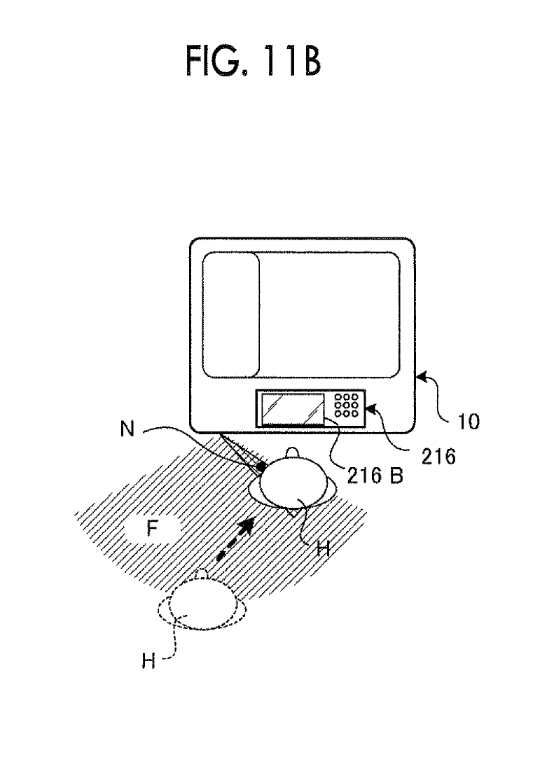

(Step 2) When the second human detection sensor 30 detects the user, the backlight unit 216BL is turned on with normal brightness (luminance) (see FIGS. 11A and 11B).

That is, as shown in FIG. 11A, when a moving body (which is represented by letter H in FIGS. 11A and 11B) is within the region F of the first human detection sensor 28 and is outside the region N of the second human detection sensor 30, the backlight unit 216BL is maintained in an off state. In this state, as shown in FIG. 11B, when the moving body enters the region N of the second human detection sensor 30, the backlight unit 216BL is turned on with normal brightness (luminance).

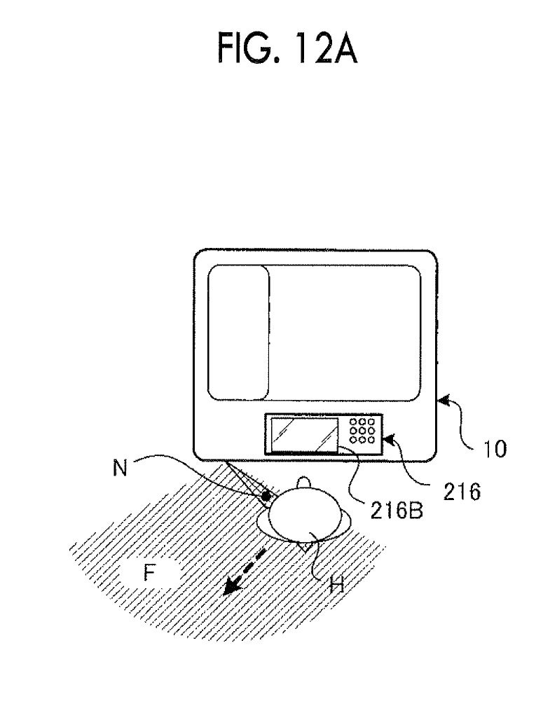

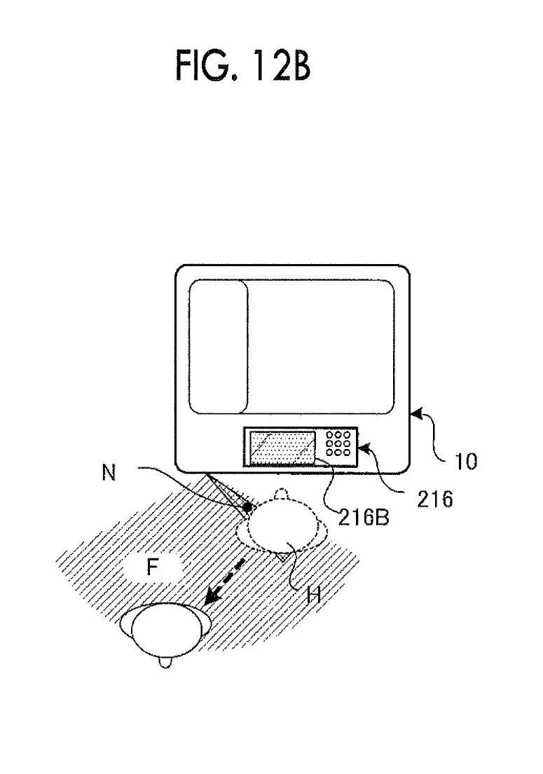

(Step 3) At the time when the user leaves the detection region (region N) of the second human detection sensor 30 without operating the input system, such as the touch panel unit 216TP, the brightness of the backlight unit 216BL is reduced by one level (see FIGS. 12A and 12B).

That is, as shown in FIG. 12A, when a moving body (which is represented by letter H in FIGS. 12A and 12B) is within the region N of the second human detection sensor 30, the backlight unit 216BL is turned on with normal brightness (luminance). In this state, as shown in FIG. 12B, when the moving body leaves the region N of the second human detection sensor 30 and moves to the region F of the first human detection sensor 28, the brightness (luminance) of the backlight unit 216BL is reduced to be less than normal brightness.

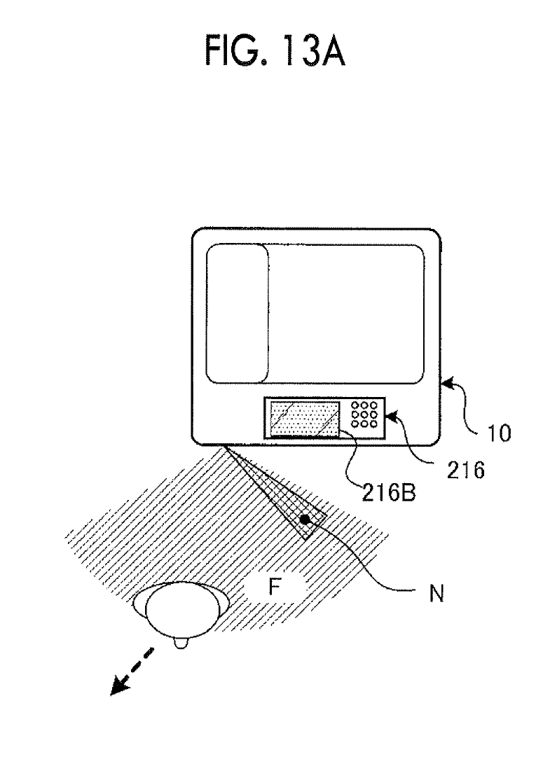

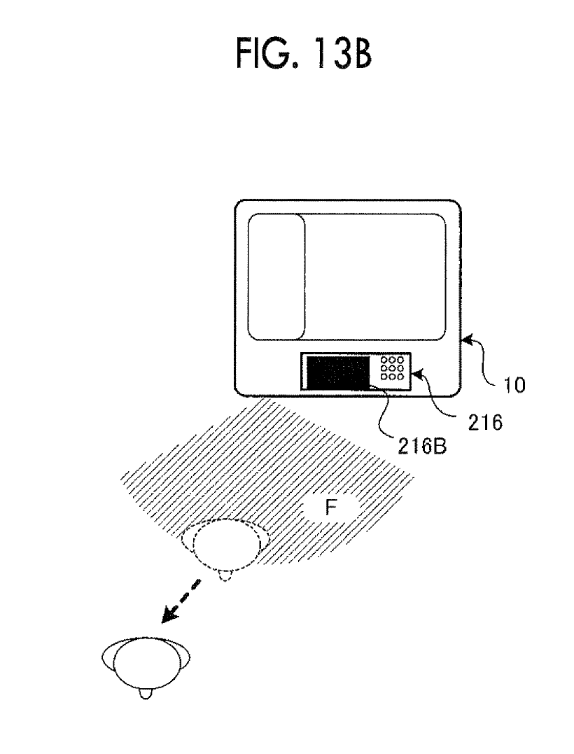

(Step 4) At the time when the user leaves the region N and also leaves the detection region (outside of region F) of the first human detection sensor 28, the brightness of the backlight unit 216BL is reduced in stages on the basis of the time measured by the timer and the backlight unit 216BL is finally turned off (see FIGS. 13A and 13B). In addition, the backlight unit 216BL may be directly turned off.

That is, as shown in FIG. 13A, when a moving body (which is represented by letter H in FIGS. 13A and 13B) is within the region F of the first human detection sensor 28, the backlight unit 216BL is turned on with brightness less than normal brightness. In this state, as shown in FIG. 138, when the moving body leaves the region F of the first human detection sensor 28, the brightness of the backlight unit 216BL is reduced in stages and the backlight unit 216BL is finally turned off. Alternatively, the backlight unit 216BL is directly turned off.

Next, the operation of this exemplary embodiment will be described.

Power Supply Control Mode Change of Image Processing Apparatus 10 (Device)

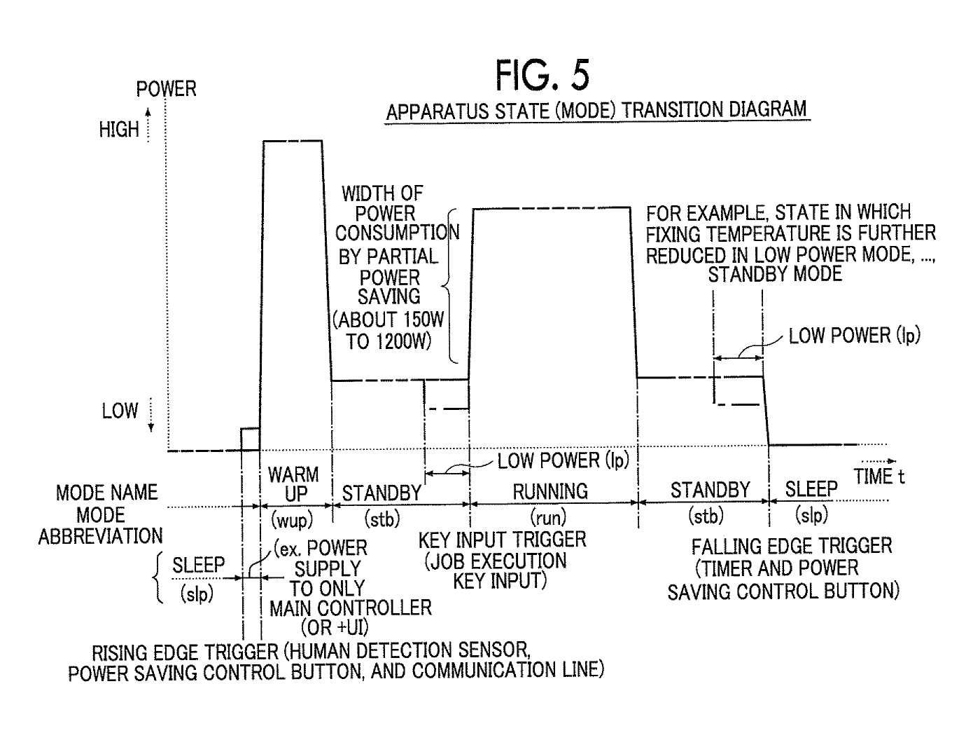

First, FIG. 5 is a timing chart illustrating each mode state and an event causing a change in the mode state in the image processing apparatus 10.

In the image processing apparatus 10, the operation state in which no process is performed is the sleep mode. In this exemplary embodiment, power is supplied only to the power saving monitoring control unit 24 in the sleep mode.

When the image processing apparatus starts by a given operation (for example, the detection of a rising edge trigger, such as a detection instruction from the user, by the second human detection sensor 30 or the operation of the power saving control button 26), the operation state is changed to the warm-up mode.

In some cases, after the rising edge trigger, the operation mode is still defined as the sleep mode. However, the amount of power supplied is more than the amount of power supplied only to the power saving monitoring control unit 24 due to the start of the main controller 200 and the UI touch panel 216. For example, in some cases, when the operation mode is returned by the operation of the power saving control button 26, the job selection mode is also returned, and the device to be started by the selected job is determined. When the image forming unit 240 does not start, warm-up is not performed.

As the rising edge trigger, for example, there may be a signal based on the detection result of the human detection sensor or operation authentication by the IC card read 217, in addition to the detection of the user by the cooperation between the first human detection sensor 28 and the second human detection sensor 30 and the power saving mode cancel operation of the user using the power saving control button 26.

In the warm-up mode, it is possible to rapidly process the image processing apparatus 10 (mainly the temperature of the fixing unit of the image forming unit 240). Among the modes, in the warm-up mode, power consumption is the maximum. However, for example, when an IH heater is used as the heater of the fixing unit, the warm-up mode time is relatively short, as compared to a structure in which a heater using a halogen lamp is used. In addition, both the IH heater and the halogen lamp may be used.

When a warm-up operation ends in the warm-up mode, the image processing apparatus 10 is changed to the standby mode. The warm-up mode has the largest power consumption (for example, 1200 W)

The standby mode is literally a mode in which “the apparatus is ready to operate”. In the standby mode, the image processing apparatus 10 may instantly perform an image processing operation.

Therefore, when a key is operated to input a job execution operation, the operation state of the image processing apparatus 10 is changed to the running mode such that the image processing apparatus 10 performs image processing based on the instructed job.

When the image processing ends (in a case in which there are plural scheduled successive jobs, when all of the successive jobs are completed), the operation state of the image processing apparatus 10 is changed to the standby mode by a standby trigger. In addition, after the image processing, time measurement by the system timer may start and the standby trigger may be output to change the operation mode to the standby mode after a predetermined time has elapsed.

When a job execution instruction is issued in the standby mode, the operation mode is changed to the running mode again and the running mode is changed to the sleep mode when a falling edge trigger is detected or when a predetermined time has elapsed. As the falling edge trigger, for example, a signal based on the detection result of the human detection sensor, a system timer, and a combination thereof may be used.

In the actual operation of the image processing apparatus 10, all of the mode states are not changed in time series as shown in the timing chart. For example, in some cases, the process is stopped in the standby mode after the warm-up mode and is changed to the sleep mode.

As such, in the image processing apparatus 10 according to this exemplary embodiment, the modes are changed to each other and power consumption is different in the modes.

In this exemplary embodiment, power supply control is performed for each device. For example, when an image reading process is instructed in the sleep mode, so-called partial power saving control may be performed in which power is supplied to the image reading unit 238 without starting the image forming unit 240.

Monitoring by First Human Detection Sensor 28 and Second Human Detection Sensor 30 in Sleep Mode

In this exemplary embodiment, in the sleep mode, basically, only the first human detection sensor 28 is supplied with power and monitors the approach of the moving body. The monitoring region (detection region) corresponds to the region F shown in FIG. 6, and the presence or absence of a moving body is detected by the analysis (variation) of an electric signal based on infrared rays which are input to the detecting unit 28A (plural detection element 314) of the first human detection sensor 28.

When the moving body is detected by the first human detection sensor 28 (the detection of the moving body in the region F shown in FIG. 6), the supply of power to the second human detection sensor 30 starts.

As shown in FIG. 6, the region N of the second human detection sensor 30 is closer to the image processing apparatus 10 than the detection region of the first human detection sensor 28 and is narrow. Therefore, the user who uses the image processing apparatus 10 is reliably recognized and power is supplied to a portion (for example, the main controller 200 and the UI touch panel 216) of or the entire image processing apparatus 10.

As such, both the first human detection sensor 28 and the second human detection sensor 30 are used to acquire the detection patterns in stages, thereby distinguishing a moving body which simply passes by the image processing apparatus 10 from the user who approaches the image processing apparatus 10 in order to use it.

Brightness Adjustment of Backlight Unit 216BL

When the power supply system is different in the approaching state and the separated state of the moving body (user), for example, when the moving body approaches the image processing apparatus 10 in order to use it, in some cases, the time when power is supplied to the image processing apparatus 10 is unclear. In the sleep mode (power saving), the on state of the backlight unit 216BL of the UI touch panel unit 216 is controlled so as to cooperate with the detection of the moving body (user) by the first human detection sensor 28 and the second human detection sensor 30.

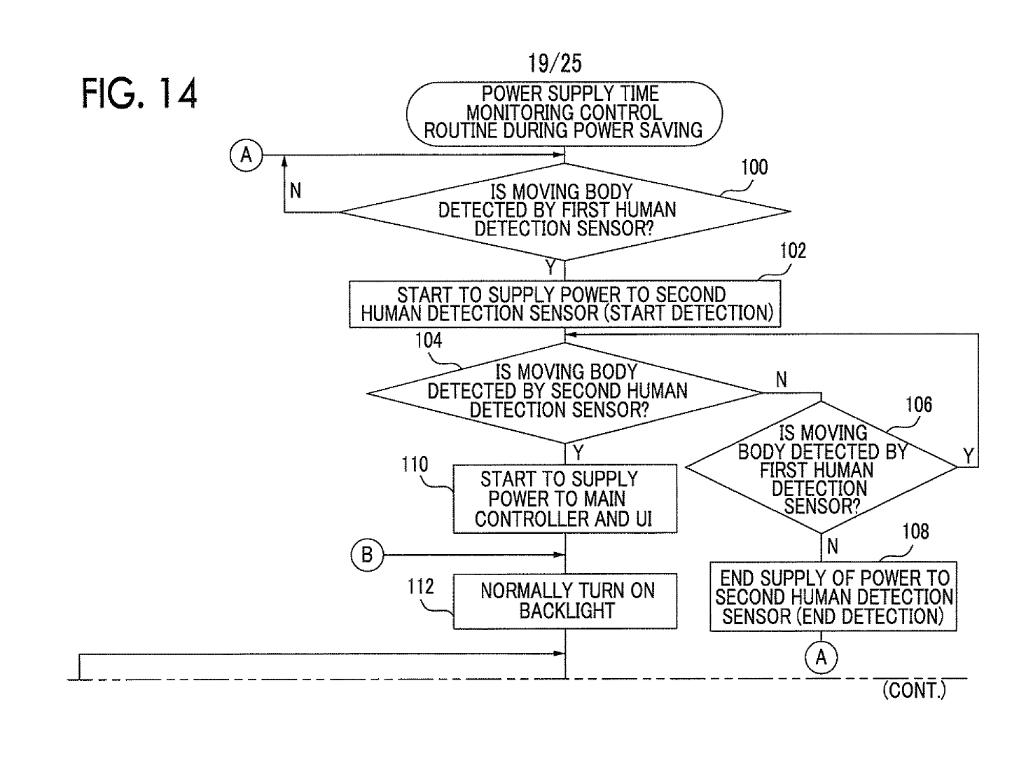

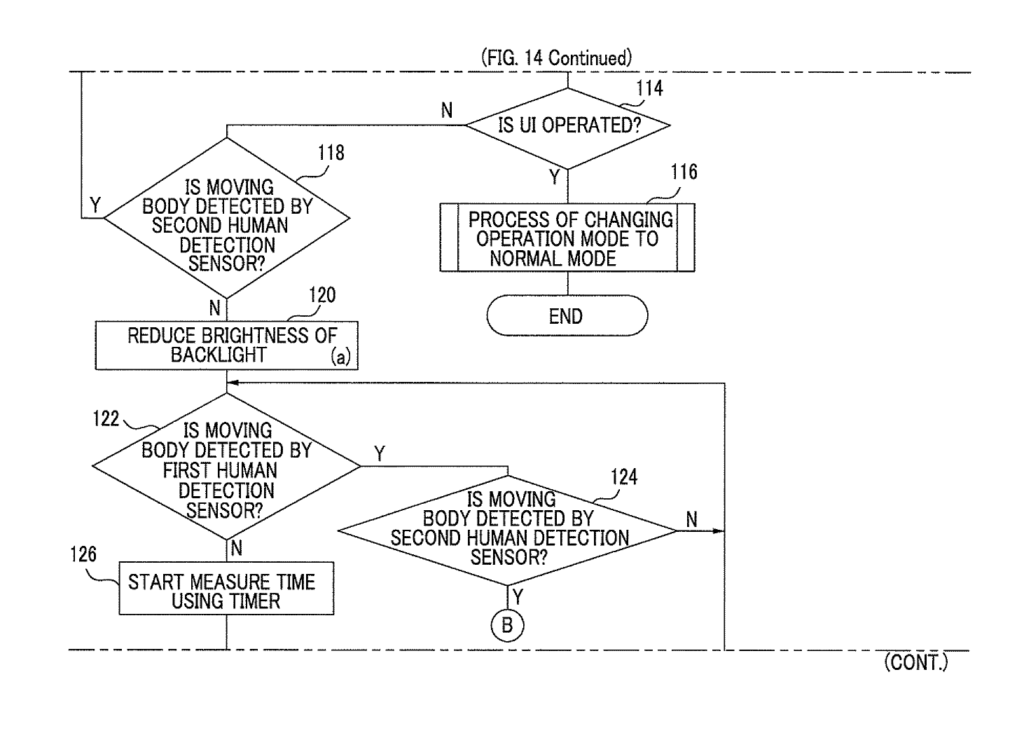

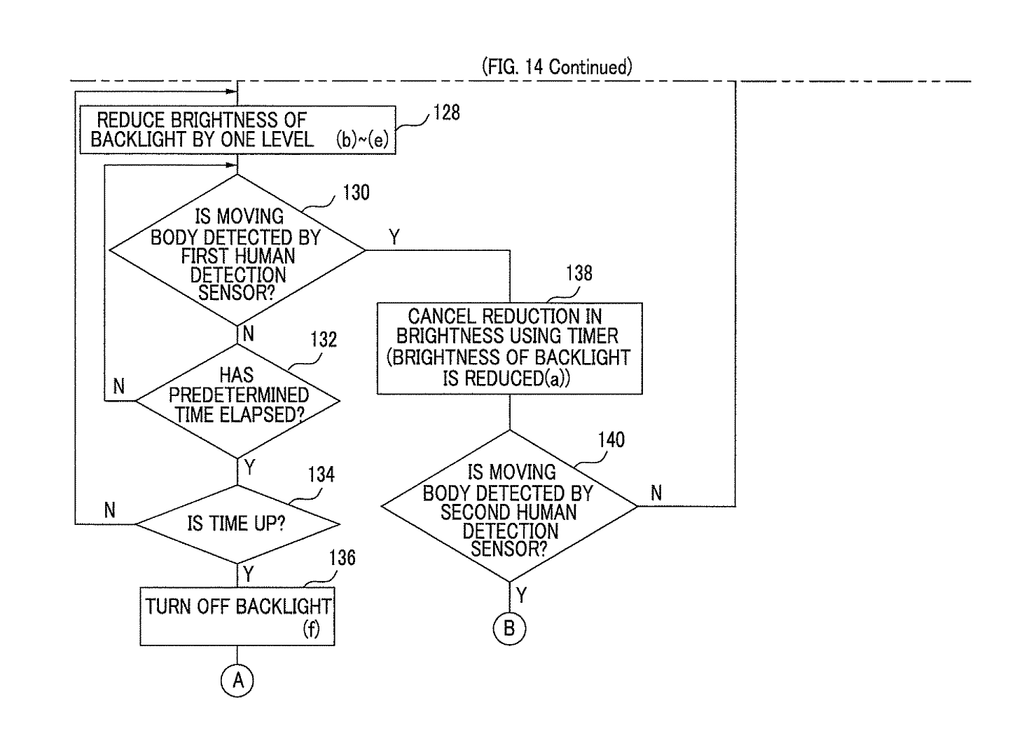

FIG. 14 is a flowchart illustrating a power supply time monitoring control routine during power saving according to this exemplary embodiment which includes the brightness adjustment of the backlight unit 216BL.

In Step 100, it is determined whether the first human detection sensor 28 detects a moving body. When the determination result is “Yes”, the process proceeds to Step 102 and the supply of power to the second human detection sensor 30 starts. In this way, the detection of the moving body by the second human detection sensor 30 starts.

Then, in Step 104, it is determined whether the second human detection sensor 30 detects a moving body (user) When the determination result is “No”, the process proceeds to Step 106 and it is determined whether the first human detection sensor 28 detects a moving body. When the determination result in Step 106 is “Yes”, it is determined that the moving body (user) is within the region F in FIG. 6 and is outside the region N and the process returns to Step 104. When the position is not changed, Steps 104 and 106 are repeatedly performed.

When the determination result in Step 106 is “No”, it is determined that the moving body (user) is separated from the image processing apparatus 10 (outside the region F in FIG. 6) and the process proceeds to Step 108. The supply of power to the second human detection sensor 30 ends (the detection of the moving body by the second human detection sensor 30 ends) and the process returns to Step 100.

On the other hand, when the determination result in Step 104 is “Yes”, it is determined that the moving body (user) enters the region N in FIG. 6 and the process proceeds to Step 110 to start the supply of power to the main controller 200 and the UI touch panel 216. Then, the process proceeds to Step 112 to normally turn on the backlight unit 216BL and the process proceeds to Step 114.

Then, in Step 114, it is determined whether the input system, such as the touch panel unit 216TP, is operated. When the determination result is “Yes”, it is determined that there is an intention to operate the image processing apparatus 10 and the process proceeds to Step 116 to change the power supply state of the image processing apparatus 10 to the normal mode. In this way, this routine ends. In the normal mode, minimum necessary power may be supplied to the devices (partial power saving control) on the basis of the operation of the user, or power may be supplied to all of the devices.

When the determination result in Step 114 is “No”, that is, the input system, such as the touch panel unit 216TP, is not operated, the process proceeds to Step 118. In Step 118, it is determined whether the second human detection sensor 30 detects a moving body (user). When the determination result in Step 118 is “Yes”, that is, for the period for which the moving body (user) is detected, it is determined that the input system, such as the touch panel unit 216TP, is likely to be operated and the process returns to Step 114.

When the determination result in Step 118 is “No”, it is determined that the moving body leaves the region N in FIG. 6 without operating the input system, such as the touch panel unit 216TP, and the process proceeds to Step 120 to reduce the brightness (luminance) of the backlight unit 216BL by one stage (dimming step (a)).

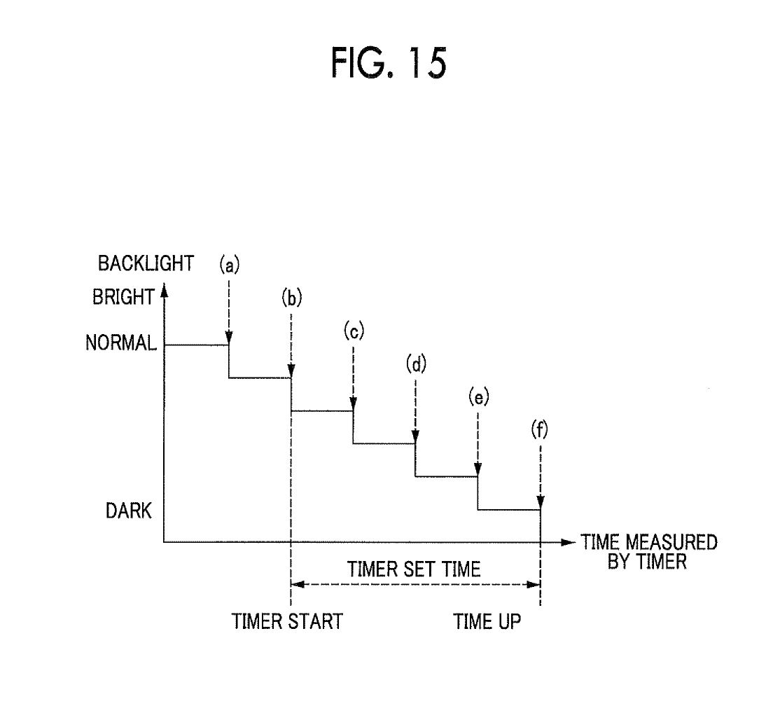

In the dimming step, the brightness (luminance) of the backlight unit 216BL may be adjusted in stages in advance, as shown in FIG. 15. In the dimming step (a), the brightness is one level lower than that in normal lighting.

Then, in Step 122, it is determined whether the first human detection sensor 28 detects a moving body (user). When the determination result is “Yes”, that is, when it is determined that the moving body is within the region F in FIG. 6, the process proceeds to Step 124 and it is determined whether the second human detection sensor 30 detects the moving body (user). When the determination result in Step 124 is “No”, that is, when it is determined that the moving body is outside the region N in FIG. 6, the process returns to Step 122 and Steps 122 and 124 are repeatedly performed while the moving body (user) stays in the region F and outside the region N in FIG. 6.

When the determination result in Step 124 is “Yes”, that is, when it is determined that the moving body (user) enters the region N in FIG. 6 again, the process returns to Step 112 to normally turn on the backlight unit 216BL and the above-mentioned process is repeatedly performed.

When the determination result in Step 122 is “No”, that is, when it is determined that the moving body (user) leaves the region F in FIG. 6, the process proceeds to Step 126 and the measurement of time by the timer starts. Then, the process proceeds to Step 128. In Step 128, the brightness (luminance) of the backlight unit 216BL is reduced by one level. The timer is a device that measures the timer set time shown in FIG. 15. When the timer starts, the dimming step is changed from (a) to (b).

Then, in Step 130, it is determined whether the first human detection sensor 28 detects a moving body. When the determination result in Step 130 is “No”, the process proceeds to Step 132 and it is determined whether a predetermined time has elapsed. When the determination result is “No”, the process returns to Step 130. When the determination result in Step 132 is “Yes”, it is determined that it is the next dimming time and the process proceeds to Step 134. It is determined in Step 134 whether the time is up (see FIG. 15). When the determination result in Step 134 is “No”, the process returns to Step 128 and the brightness of the backlight unit 216BL is reduced by one level. That is, as shown in FIG. 15, when the timer starts, after the dimming step (b), the brightness of the backlight unit 216BL is gradually reduced to the dimming steps (c) to (e) at a predetermined time interval. The number of steps is not limited. Speaking in the extreme, the brightness may be continuously and gradually reduced on the basis of a predetermined rate of change.

When the determination result in Step 134 is “Yes”, that is, when the time is up, the process proceeds to Step 136 and the backlight unit 216BL is completely turned off. That is, the operation mode returns to the sleep mode and the process returns to Step 100.

When the determination result in Step 130 is “Yes”, it is determined that the moving body (user) enters the region F in FIG. 6 again and the process proceeds to Step 138 to cancel the dimming operation by the measurement of time by the timer (the brightness (luminance) of the backlight unit 216BL is changed to the dimming step (a)). Then, the process proceeds to Step 140. In Step 140, it is determined whether the second human detection sensor 30 detects the moving body (user). When the determination result is “No”, the process returns to Step 122. When the determination result is “Yes”, the process returns to Step 112.

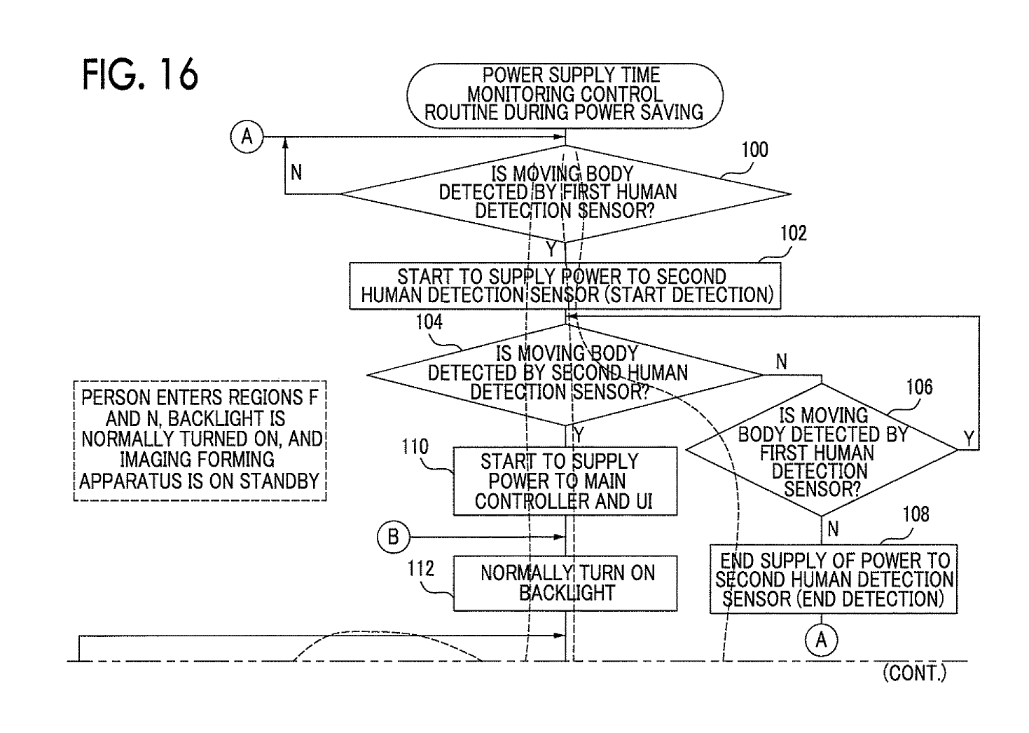

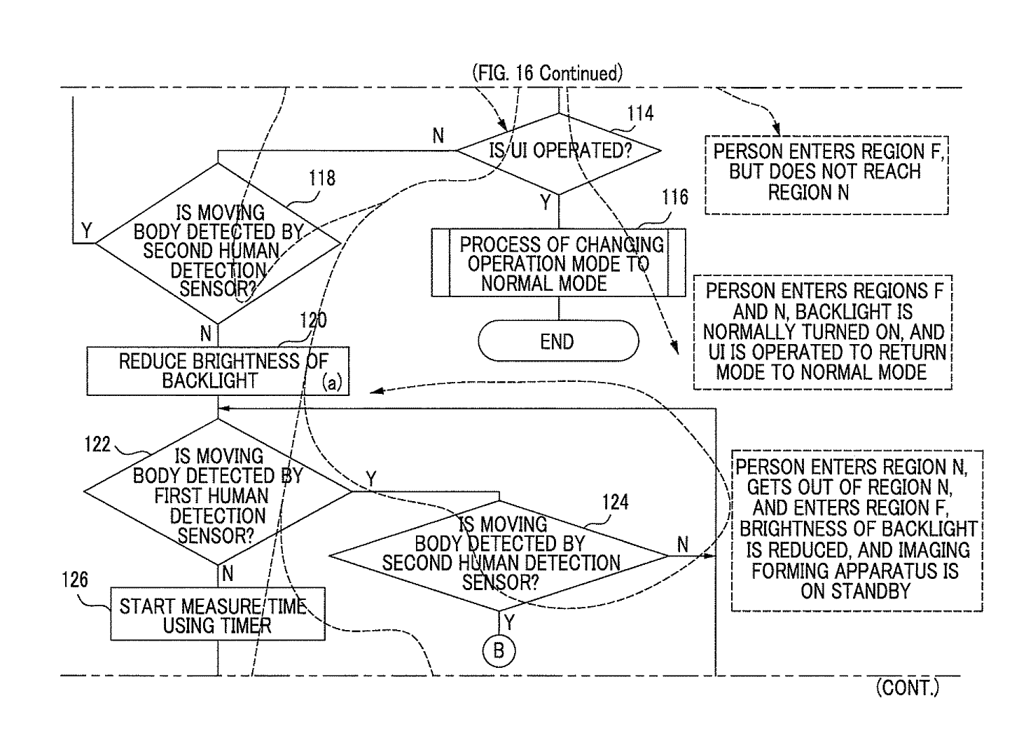

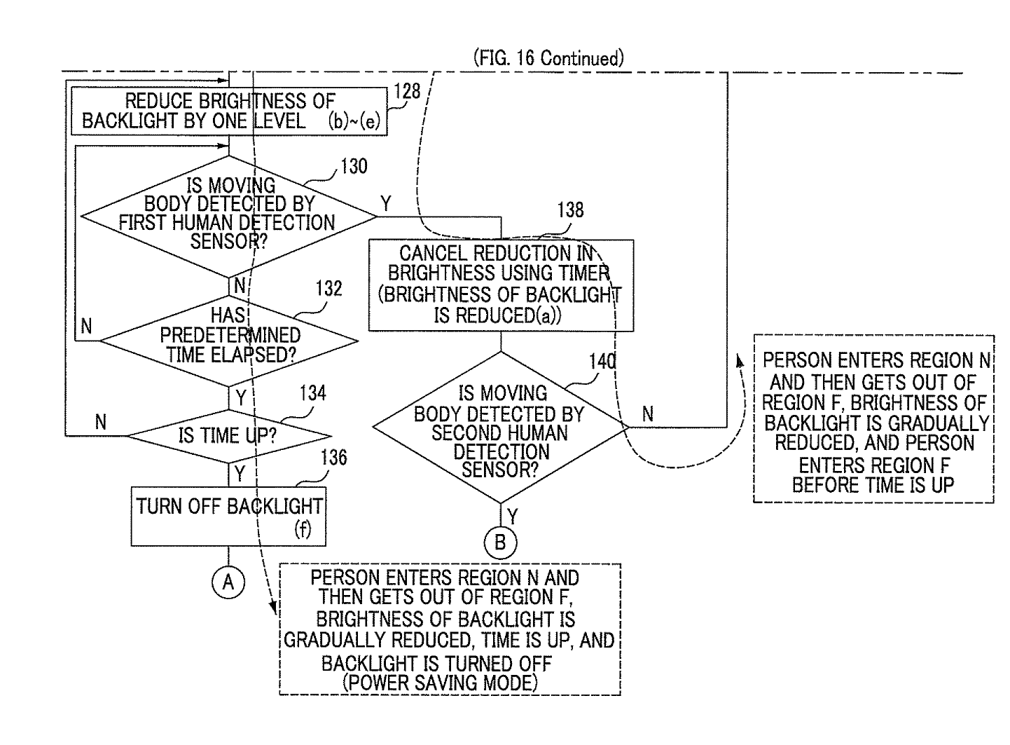

Dotted arrows shown in FIG. 16 indicate the main change in the moving body (user) in the flowchart shown in FIG. 14. In each dotted arrow, since the brightness (luminance) of the backlight unit 216BL is changed, the user may recognize the power supply state of the image processing apparatus 10 without looking away from the UI touch panel 216.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A power supply control device comprising:
a user interface unit including a touch panel unit that has a display function of displaying indication information for indicating a process of a processing apparatus body and process information about the process of the processing apparatus body and an input function of enabling a user to touch a display region of the indication information to designate the indication information and a backlight unit that is turned on, on the rear side of the touch panel unit to clarify the display content;
a control unit that controls the process of the processing apparatus body including the display function and the input function of the touch panel unit;
at least two types of moving body detecting units that are capable of detecting a moving body which moves around the processing apparatus body and have at least relatively short and long detectable distances;
a stepwise power supply unit that supplies power to the control unit when one of the moving body detecting units with a short detection distance starts detection at the time when the other movement detecting unit with a long detection distance detects the moving body and detects the moving body; and
an adjustment unit that, when the one moving body detecting unit does not detect the moving body with power supplied to the control unit, first adjusts the brightness of the backlight unit to predetermined brightness less than normal brightness.

2. The power supply control device according to claim 1, further comprising:
a power cutoff unit that cuts the supply of power such that the backlight unit is first turned off when the other moving body detecting unit does not detect the moving body, with the brightness of the backlight unit being reduced to the predetermined brightness by the adjustment unit.

3. The power supply control device according to claim 1, further comprising:
a timer unit that measures time up to a predetermined time limit when the other moving body detecting unit does not detect the moving body, with the brightness of the backlight unit being reduced to the predetermined brightness by the adjustment unit; and
a stepwise power reducing unit that cuts the supply of power such that the brightness of the backlight unit is reduced in stages from the predetermined brightness according to the length of the time measured by the timer unit and the backlight unit is turned off at the time limit.

4. The power supply control device according to claim 1,
wherein, when the supply of power to the backlight unit is cut, the supply of power to the entire user interface unit is cut.

5. The power supply control device according to claim 2,
wherein, when the supply of power to the backlight unit is cut, the supply of power to the entire user interface unit is cut.

6. The power supply control device according to claim 3,
wherein, when the supply of power to the backlight unit is cut, the supply of power to the entire user interface unit is cut.

7. The power supply control device according to claim 1,
wherein the stepwise power supply unit turns on the backlight unit with the predetermined brightness in addition to supplying power to the one moving body detecting unit with the short detection distance of the moving body detecting units at the time when the other moving body detecting unit with the long detection distance detects the moving body, and
the stepwise power supply unit turns on the backlight unit with the normal brightness in addition to supplying power to the control unit at the time when the one moving body detecting unit detects the moving body.

8. The power supply control device according to claim 2,
wherein the stepwise power supply unit turns on the backlight unit with the predetermined brightness in addition to supplying power to the one moving body detecting unit with the short detection distance of the moving body detecting units at the time when the other moving body detecting unit with the long detection distance detects the moving body, and
the stepwise power supply unit turns on the backlight unit with the normal brightness in addition to supplying power to the control unit at the time when the one moving body detecting unit detects the moving body.

9. The power supply control device according to claim 3,
wherein the stepwise power supply unit turns on the backlight unit with the predetermined brightness in addition to supplying power to the one moving body detecting unit with the short detection distance of the moving body detecting units at the time when the other moving body detecting unit with the long detection distance detects the moving body, and
the stepwise power supply unit turns on the backlight unit with the normal brightness in addition to supplying power to the control unit at the time when the one moving body detecting unit detects the moving body.

10. The power supply control device according to claim 4,
wherein the stepwise power supply unit turns on the backlight unit with the predetermined brightness in addition to supplying power to the one moving body detecting unit with the short detection distance of the moving body detecting units at the time when the other moving body detecting unit with the long detection distance detects the moving body, and
the stepwise power supply unit turns on the backlight unit with the normal brightness in addition to supplying power to the control unit at the time when the one moving body detecting unit detects the moving body.

11. The power supply control device according to claim 5,
wherein the stepwise power supply unit turns on the backlight unit with the predetermined brightness in addition to supplying power to the one moving body detecting unit with the short detection distance of the moving body detecting units at the time when the other moving body detecting unit with the long detection distance detects the moving body, and
the stepwise power supply unit turns on the backlight unit with the normal brightness in addition to supplying power to the control unit at the time when the one moving body detecting unit detects the moving body.

12. The power supply control device according to claim 6,
wherein the stepwise power supply unit turns on the backlight unit with the predetermined brightness in addition to supplying power to the one moving body detecting unit with the short detection distance of the moving body detecting units at the time when the other moving body detecting unit with the long detection distance detects the moving body, and
the stepwise power supply unit turns on the backlight unit with the normal brightness in addition to supplying power to the control unit at the time when the one moving body detecting unit detects the moving body.

13. The power supply control device according to claim 1,
wherein the detecting unit includes:
a pyroelectric sensor that detects the entrance of the moving body in a relatively wide detection region, and
a reflective sensor that detects the approach of the user to the processing apparatus in a relatively narrow detection region.

14. The power supply control device according to claim 2,
wherein the detecting unit includes:
a pyroelectric sensor that detects the entrance of the moving body in a relatively wide detection region, and
a reflective sensor that detects the approach of the user to the processing apparatus in a relatively narrow detection region.

15. The power supply control device according to claim 3,
wherein the detecting unit includes:
a pyroelectric sensor that detects the entrance of the moving body in a relatively wide detection region, and
a reflective sensor that detects the approach of the user to the processing apparatus in a relatively narrow detection region.

16. The power supply control device according to claim 4,
wherein the detecting unit includes:
a pyroelectric sensor that detects the entrance of the moving body in a relatively wide detection region, and
a reflective sensor that detects the approach of the user to the processing apparatus in a relatively narrow detection region.

17. The power supply control device according to claim 5,
wherein the detecting unit includes:
a pyroelectric sensor that detects the entrance of the moving body in a relatively wide detection region, and
a reflective sensor that detects the approach of the user to the processing apparatus in a relatively narrow detection region.

18. The power supply control device according to claim 13,
wherein power is constantly supplied to the pyroelectric sensor, and
power is supplied to the reflective sensor at the time when the pyroelectric sensor detects the entrance of the moving body.

19. An image processing apparatus comprising:
the power supply control device according to claim 1; and
an individual power supply unit,
wherein the image processing apparatus body includes at least one of an image reading unit that reads an image from a document image, an image forming unit that forms an image on a recording sheet on the basis of image information, and a facsimile communication processing unit that transmits and receives an image according to a predetermined communication sequence, and
the individual power supply unit cuts the supply of power to the processing unit that is not operated when the backlight unit is turned off, in synchronization with the time when the backlight unit is turned off.

20. A non-transitory computer readable medium storing a power supply control program that causes a computer to function as the power supply control device according to claim 1.
